(19) United States
(12) Patent Application Publication
(10) Pub. No.: US 2024/0283817 A1
(43) Pub. Date: Aug. 22, 2024

(54) SWITCH, NETWORK CONTROLLER, COMMUNICATION CONTROL METHOD, AND COMMUNICATION CONTROL PROGRAM

(71) Applicant: NIPPON TELEGRAPH AND TELEPHONE CORPORATION, Tokyo (JP)

(72) Inventors: Rintaro HARADA, Musashino-shi, Tokyo (JP); Naotaka SHIBATA, Musashino-shi, Tokyo (JP); Shin KANEKO, Musashino-shi, Tokyo (JP)

(73) Assignee: NIPPON TELEGRAPH AND TELEPHONE CORPORATION, Tokyo (JP)

(21) Appl. No.: 18/563,932

(22) PCT Filed: May 28, 2021
(86) PCT No.: PCT/JP2021/020445

§ 371 Date: Nov. 24, 2023

(51) Int. Cl. H04L 9/40

(52) U.S. Cl. CPC H04L 63/1458

(57) ABSTRACT

A switch in a communication network comprises a controller for controlling a communication flow in the communication network. A suspected flow is a communication flow suspected of being related to a DDoS (Distributed Denial of Service) attack. A normal flow is a communication flow other than the suspected flow. The controller is configured to execute provisional handling when receiving a provisional handling instruction indicating identification information of the suspected flow from a network controller. The provisional handling includes processing of setting a priority of the suspected flow to a designated priority, and processing of setting a priority of the normal flow higher than the designated priority.

### TITLE OF INVENTION

### Technical Field

The present invention relates to a communication system including a switch for controlling a communication flow in a communication network. In particular, the present invention relates to addressing a distributed denial of service (DDOS) attack in a communication system including a switch for controlling a communication flow in a communication network.

### BACKGROUND ART

PTL 1 discloses a communication control system having a plurality of layer 2 switches and a network controller. A communication (relay) network is constituted by a plurality of layer 2 switches. A terminal such as an IoT terminal communicates with the server via the layer 2 switch. Each layer 2 switch controls a communication flow in a communication network. The network controller is communicably connected to each layer 2 switch and controls each layer 2 switch.

A DDoS attack is known in which a large amount of attack traffic is transmitted from a terminal infected with malware or the like. When a DDoS attack occurs, the network band is tight, and a frame of a normal communication flow (normal flow) may be discarded. Therefore, a DDoS attack detection server for detecting DDoS attack is provided. When the DDoS attack is detected, the switch interrupts the attack traffic. However, there is a case where it takes time to detect an attack by the DDoS attack detection server, and in this case, the frame discard of the normal flow continues until the attack traffic is interrupted.

According to the technique disclosed in PTL 1, before detecting an attack by a DDoS attack detection server, a network controller detects a communication flow suspected to be related to the attack as a “suspected flow”. Then, the network controller transmits an instruction for reducing the priority of transfer processing to the suspected flow to a target switch handling the suspected flow. The target switch reduces priority of transfer processing to the suspected flow according to an instruction from the network controller.

### CITATION LIST

### Patent Literature

[PTL 1] Japanese Patent Application Publication No. 2020-31363

### SUMMARY OF INVENTION

### Technical Problem

According to the technique described in PTL 1, the priority of the suspected flow is lowered before the DDoS attack detection server detects an attack. As a result, data discard of a normal flow having higher priority than the priority of the suspected flow after the reduction is suppressed. However, the data discard of the normal flow below the priority of the suspected flow after the decrease still continues.

An object of the present invention is to provide a technique capable of suppressing data discard of a normal communication flow that is not related to a DDoS attack in a communication system including a switch for controlling a communication flow.

### Solution to Problem

A first aspect relates to a switch in a communication network.

A switch comprises a controller for controlling a communication flow in the communication network.

A suspected flow is a communication flow suspected of being related to a DDoS attack.

A normal flow is a communication flow other than the suspected flow.

The controller is configured to execute provisional handling when receiving a provisional handling instruction indicating identification information of the suspected flow from a network controller.

The provisional handling includes processing of setting a priority of the suspected flow to a designated priority, and processing of setting a priority of the normal flow higher than the designated priority.

A second aspect relates to a network controller connected to a switch for controlling a communication flow in a communication network.

The network controller includes a controller for communicating with the switch.

The suspected flow is a communication flow suspected of being related to a DDoS attack and a normal flow is a communication flow other than the suspected flow.

The controller is configured to perform processing of acquiring feature amount information indicating a feature amount for each of the communication flows from the switch, processing of detecting the suspected flow on the basis of the feature amount information, and processing of instructing the switch to execute provisional handling when the suspected flow is detected.

The provisional handling includes processing of setting a priority of the suspected flow to a designated priority, and processing of setting a priority of the normal flow higher than the designated priority.

A third aspect relates to a communication control method in a communication system including a switch for controlling a communication flow in a communication network.

A communication control method includes processing of acquiring feature amount information indicating a feature amount for each of the communication flows, processing of detecting a suspected flow that is the communication flow suspected to be related to a DDoS attack on the basis of the feature amount information, and processing that executes provisional handling when the suspected flow is detected.

The provisional handling includes processing of setting a priority of the suspected flow to a designated priority and processing of setting priority of a normal flow that is the communication flow other than the suspected flow higher than the designated priority.

A fourth aspect relates to a communication control program for controlling a switch in a communication network.

The communication control program causes the switch to control a communication flow in the communication network by being executed by a computer included in the switch.

A suspected flow is a communication flow suspected of being related to a DDoS attack.

A normal flow is a communication flow other than a suspected flow.

The communication control program causes the switch to execute provisional handling when receiving a provisional handling instruction indicating identification information of the suspected flow from a network controller.

The provisional handling includes processing of setting a priority of the suspected flow to a designated priority and processing of setting a priority of the normal flow higher than the designated priority.

### Advantageous Effects of Invention

According to the present disclosure, when a suspected flow is detected, a provisional handling is performed. In the provisional handling, the priority of the suspected flow is set to the designated priority, and the priority of the normal flow is set higher than the designated priority. This makes it possible to suppress data discard of the normal flow even when network band is strained due to DDoS attack. In particular, it is possible to suppress data discard of the normal flow that originally had low priority.

### BRIEF DESCRIPTION OF DRAWINGS

FIG. 1 is a block diagram schematically showing an example configuration of a communication system according to an embodiment of the present disclosure.

FIG. 2 is a conceptual diagram for explaining provisional handling according to an embodiment of the present disclosure.

FIG. 3 is a conceptual diagram for explaining an example of control method of priority of a communication flow according to an embodiment of the present disclosure.

FIG. 4 is a conceptual diagram for explaining formal handling according to an embodiment of the present disclosure.

FIG. 5 is a block diagram showing a configuration example of a switch according to an embodiment of the present disclosure.

FIG. 6 is a block diagram showing an example configuration of a network controller according to an embodiment of the present disclosure.

FIG. 7 is a block diagram showing an example of a functional configuration related to provisional handling and formal handling according to an embodiment of the present disclosure.

FIG. 8 is a conceptual diagram showing an example of feature amount information according to an embodiment of the present disclosure.

FIG. 9 is a conceptual diagram showing an example of abnormal feature amount information according to an embodiment of the present disclosure.

FIG. 10 is a flowchart concisely showing a processing related to provisional handling and formal handling according to an embodiment of the present disclosure.

FIG. 11 is a block diagram for explaining a first example of priority control in provisional handling according to an embodiment of the present disclosure.

FIG. 12 is a conceptual diagram for explaining a first example of priority control in provisional handling according to an embodiment of the present disclosure.

FIG. 13 is a conceptual diagram for explaining a second example of priority control in provisional handling according to an embodiment of the present disclosure.

FIG. 14 is a flowchart showing a third example of priority control provisional handling according to an embodiment of the present disclosure.

FIG. 15 is a block diagram for explaining a fourth example of priority control in provisional handling according to an embodiment of the present disclosure.

FIG. 16 is a conceptual diagram for explaining an example of queue length information according to an embodiment of the present disclosure.

FIG. 17 is a conceptual diagram for explaining a fourth example of priority control in provisional handling according to an embodiment of the present disclosure.

FIG. 18 is a block diagram showing an example of functional configuration related to provisional handling considering the suspected section according to an embodiment of the present disclosure.

FIG. 19 is a conceptual diagram for explaining an example of provisional handling that take into account the suspected section according to an embodiment of the present disclosure.

### DESCRIPTION OF EMBODIMENTS

Embodiments of the present invention will be described with reference to the accompanying drawings.

### 1. Overview

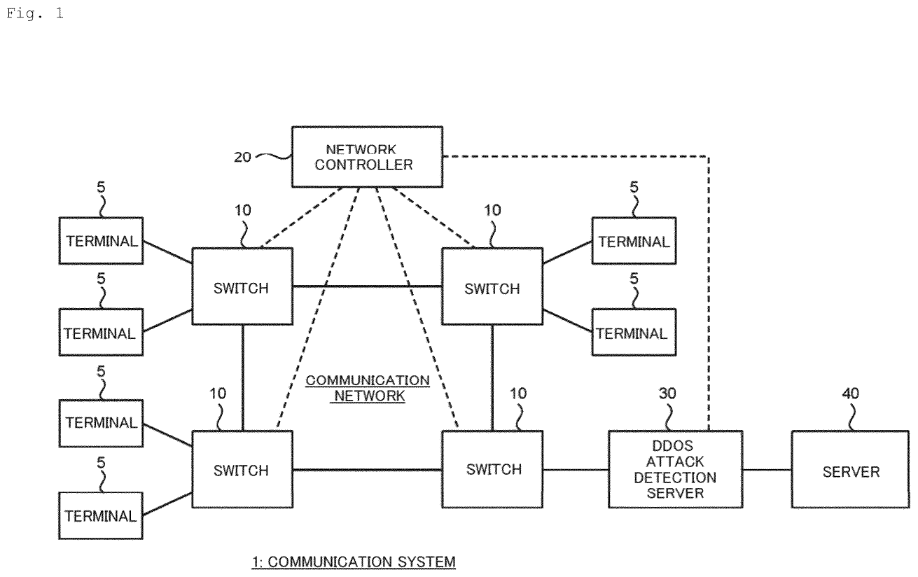

FIG. 1 is a block diagram schematically showing an example of a configuration of a communication system 1 according to the present embodiment. A communication system 1 includes a plurality of terminals 5, a plurality of switches 10, a network controller 20, a distributed denial of service (DDoS) attack detection server, and a server 40. As the terminal 5, an IoT (Internet of Things) terminal, a mobile terminal, and the like are exemplified. As the switch 10, a layer 2 (L2) switch is exemplified. An IoT server is exemplified as the server 40.

A communication (relay) network is constituted by a plurality of switches 10. A plurality of terminals 5 are accommodated in that communication network. The terminal 5 communicates with the server 40 via the switch 10. Each switch 10 controls a communication flow in the communication network. The network controller 20 is communicably connected to each switch 10 and controls each switch 10.

A DDoS attack detection server 30 detects a DDoS attack in which a large amount of attack traffic is transmitted from the terminal 5 infected with malware or the like. The DDoS attack detection server 30 is communicably connected to each switch 10 and the network controller 20. In the example shown in FIG. 1, the DDoS attack detection server 30 is installed in the front stage of the server 40.

When a DDoS attack occurs, network band is strained and some data in normal communication flows may be discarded. Since packet retransmission caused by data discard drain the limited battery of terminal 5, it is desirable to quickly suppress data discards of normal communication flows. However, there are cases where it takes time to detect an attack by the DDoS attack detection server 30, and there are cases where it takes time to interrupt the attack traffic. Therefore, according to the present embodiment, in order to quickly suppress data discard of a normal communication flow, before the detection of the attack by the DDoS attack detection server 30, the “provisional handling” described below is performed.

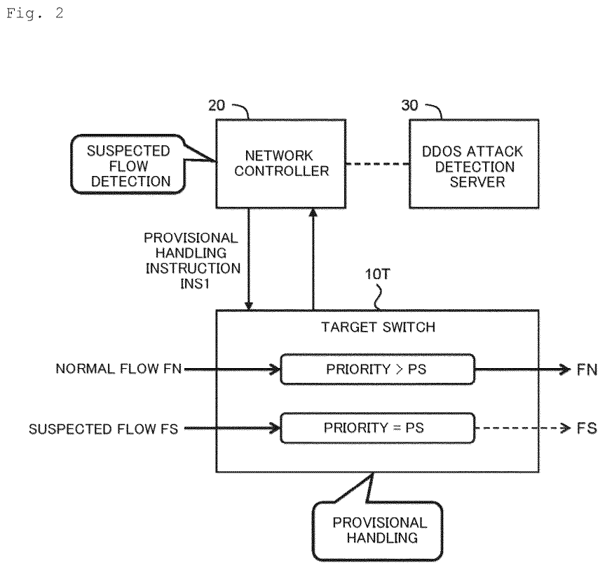

FIG. 2 is a conceptual diagram for explaining an overview of provisional handling according to the present embodiment. A communication flow that is not determined but likely to be related to a DDoS attack, that is, a communication flow that is suspected to be related to a DDoS attack, “suspected flow FS”. A communication flow other than the suspected flow FS, that is, a communication flow not related to the DDoS attack, is hereinafter referred to as “normal flow FN”. The “suspected flow” may be paraphrased with the “suspected traffic”, and the “normal flow” may be paraphrased with the “normal traffic”.

The network controller 20 receives information on a communication flow handled by each switch 10 from each switch 10. Then, the network controller 20 determines whether or not the suspected flow FS exists on the basis of the information regard to the communication flow. An example of a method for determining the suspected flow FS will be described later in detail.

When the suspected flow FS is detected, the network controller 20 transmits a “provisional handling instruction INS1” to at least one target switch 10T. A target switch 10T is a switch 10 handling a suspected flow FS. For example, the target switch 10T is a switch 10 which is an entrance of a suspected flow FS in a communication network. The provisional handling instruction INS1 is information for instructing the target switch 10T to execute provisional handling, and includes at least identification information of the suspected flow FS. The identification information is, for example, a VLAN ID (VID).

When receiving the provisional handling instruction INS1 from the network controller 20, the target switch 10T executes the provisional handling according to the provisional handling instruction INS1. In the provisional handling, the target switch 10T adjusts “priority” of the suspected flow FS and the normal flow FN.

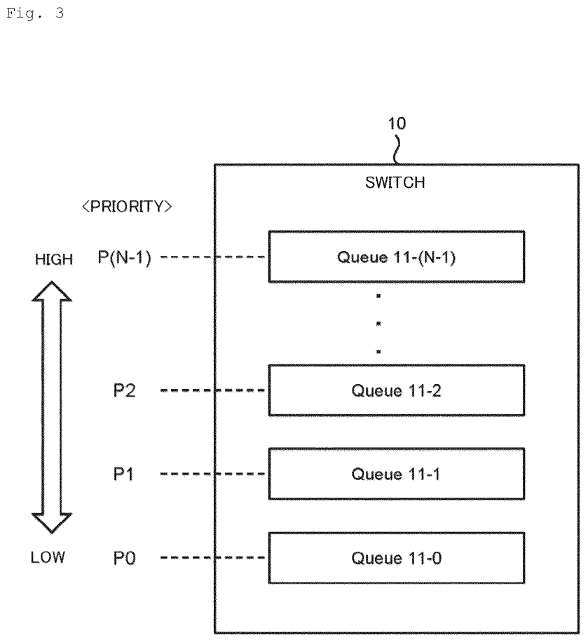

FIG. 3 is a conceptual diagram for explaining the priority of the communication flow. One of N-stage priorities P0 to P (N-1) is assigned to each communication flow. Here, N is an integer of 2 or more. The priority P0 is the lowest and the priority P (N-1) is the highest. As the priority is higher, the switch 10 transfers the data (frame) of the communication flow more preferentially. That is, the higher the priority, the higher the data transfer rate by the switch 10.

For example, as shown in FIG. 3, queues 11 are provided for each priority. That is, the switch 10 is provided with a plurality of kinds of queues 11-0 to 11-(N-1) provided for each of a plurality of priorities P0 to P (N-1). The data (frame) of the communication flow is stored in the queue 11 associated with the priority of the communication flow. The data transmission frequency from each queue 11 depends on the priority, and the higher the priority queue 11, the higher the data transmission frequency. As a result, the higher priority communication flow, the higher the data transfer rate. Conversely, the lower priority communication flow, the lower the data transfer rate.

As shown in FIG. 2, in the provisional handling, the target switch 10T sets the priority of the suspected flow FS to “designated priority PS”. The designated priority PS is a relatively low priority. For example, the designated priority PS is the lowest priority P0. Further, the target switch 10T sets the priority of the normal flow FN higher than the designated priority PS. For example, when the designated priority PS is the lowest priority P0, the target switch 10T sets the priority of the suspected flow FS to the lowest priority P0, the priority of the normal flow FN is set higher than the lowest priority P0. Thus, even in a situation where a network band is tight due to DDoS attack, the data discard of the normal flow FN can be quickly suppressed. In particular, it is possible to quickly suppress the data discard of the normal flow FN whose original priority is low.

On the other hand of the provisional handling, the DDoS attack detection server 30 precisely determines whether or not the suspected flow FS is caused by the DDoS attack on the basis of the data of the suspected flow FS. Then, the DDoS attack detection server 30 notifies the network controller 20 of information indicating the determination result. According to the determination result by the DDoS attack detection server 30, “formal handling” described below is executed.

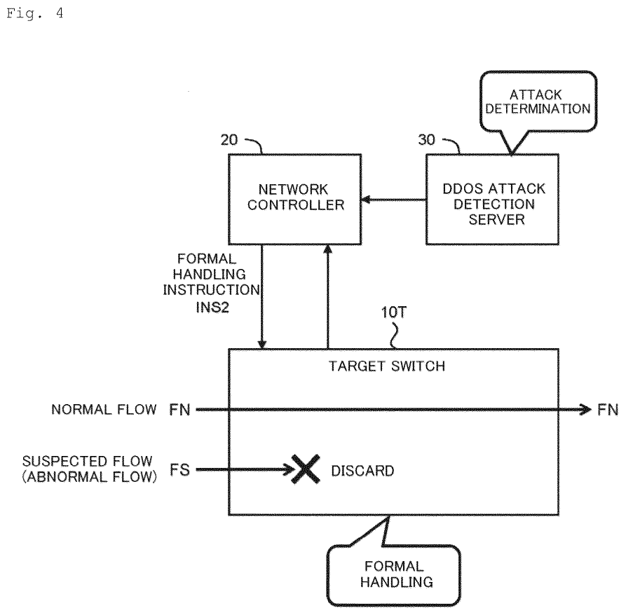

FIG. 4 is a conceptual diagram for explaining a formal handling according to the present embodiment. The network controller 20 receives information indicating a determination result by the DDoS attack detection server 30. When it is determined that the suspected flow FS is an abnormal flow for performing DDoS attack, the network controller 20 transmits a “formal handling instruction INS2” to the target switch 10T. The formal handling instruction INS2 is information for instructing the target switch 10T to execute formal handling, and includes at least identification information of a suspected flow FS (abnormal flow). The identification information is, for example, a transmission source IP address.

When receiving the formal handling instruction INS2 from the network controller 20, the target switch 10T executes formal handling according to the formal handling instruction INS2. Specifically, the target switch 10T cuts off the suspected flow FS (abnormal flow) by discarding the frame of the suspected flow FS (abnormal flow). The target switch 10T returns the priority of the normal flow FN to the original priority (that is, the priority before the provisional handling).

When it is determined that the suspected flow FS does not perform DDoS attack, the network controller 20 transmits a “restoration instruction” to the target switch 10T described above. The restoration instruction instructs to return the priority changed in the provisional handling to the original priority before the provisional handling. The target switch 10T returns the priority of the suspected flow FS from the designated priority PS to the original priority according to the restoration instruction, and returns the priority of the normal flow FN to the original priority.

As described above, according to the present embodiment, when the suspected flow FS is detected by the network controller 20, a provisional handling is performed. In the provisional handling, the priority of the suspected flow FS is set to the designated priority PS, and the priority of the normal flow FN is set higher than the designated priority PS. Thus, even in a situation where a network band is tight due to DDoS attack, the data discard of the normal flow FN can be suppressed. In particular, it is possible to suppress the data discard of the normal flow FN whose original priority is low.

In addition, the above provisional handling is executed before the detection of the attack by the DDoS attack detection server 30. Thus, the data discard of the normal flow FN can be quickly suppressed.

The packet retransmission caused by the data discard consumes a limited battery of the terminal 5. According to the present embodiment, since the data discard is suppressed, packet retransmission caused by the data discard is also suppressed, and battery consumption in the terminal 5 is also suppressed.

### 2. Basic Configuration and Basic Processing

### 2-1. Basic Configuration

### 2-1-1. Switch

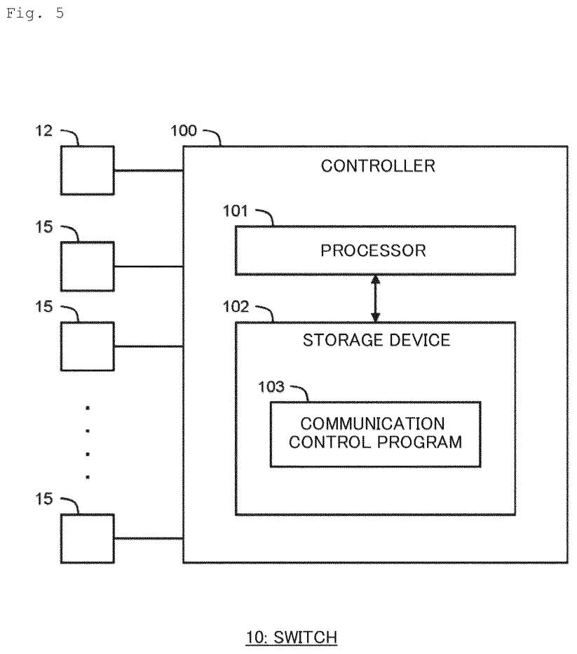

FIG. 5 is a block diagram showing a configuration example of the switch 10 according to the present embodiment. The switch 10 includes a port 12, a port 15, and a controller 100. The port 12 is connected to the network controller 20. The port 15 is connected to a terminal 5, another switch 10, a server 40, and the like.

The controller 100 controls a communication flow. For example, the controller 100 performs a flow transfer processing for receiving data (frame) of a communication flow from a port 15 and outputting the data from another port 15. The controller 100 holds a transfer table indicating a combination of an input port and an output port for each communication flow, and performs flow transfer processing on the basis of the transfer table.

The controller 100 may receive an instruction from the network controller 20 via the port 12 and execute various processes according to the instruction. For example, the controller 100 performs provisional handling according to the provisional handling instruction INS1. As another example, the controller 100 performs formal handling according to the formal handling instruction INS2. As further another example, the controller 100 may rewrite the transfer table.

The controller 100 includes one or more processors 101 (hereinafter simply referred to as “processor 101”) and one or more storage devices 102 (hereinafter simply referred to as “storage devices 102”). Processor 101 performs various types of information processing. For example, processor 101 includes a CPU (Central Processing Unit). The storage device 102 stores various information necessary for processing by the processor 101. Examples of the storage device 102 include volatile memory, nonvolatile memory, HDD (Hard Disk Drive), SSD (Solid State Drive), and the like.

The communication control program 103 is a computer program executed by the processor 101. The function of the controller 100 is realized by the cooperation of the processor 101 executing the communication control program 103 and the storage device 102. The communication control program 103 is stored in the storage device 102. The communication control program 103 may be recorded on a computer-readable recording medium. The communication control program 103 may be provided to the controller 100 via a network.

As another example, the controller 100 may be realized with use of hardware such as an ASIC (Application Specific Integrated Circuit), a PLD (Programmable Logic Device), or an FPGA (Field Programmable Gate Array).

### 2-1-2. Network Controller

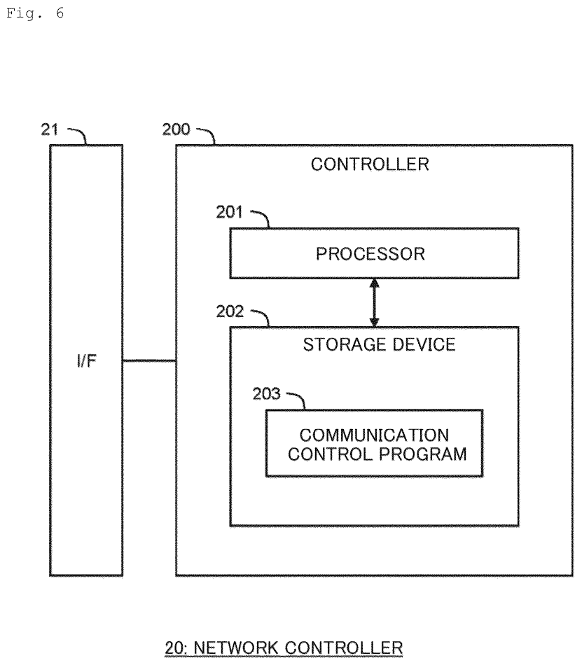

FIG. 6 is a block diagram showing an example configuration of the network controller 20 according to the present embodiment.

The network controller 20 includes a communication interface 21 and a controller 200. The communication interface 21 is connected to the plurality of switches 10 and the DDoS attack detection server 30.

The controller 200 communicates with the DDoS attack detection server 30 via the communication interface 21. The controller 200 communicates with each switch 10 via a communication interface 21 to control each switch 10. For example, the controller 200 detects a suspected flow FS and transmits a provisional handling instruction INS1 and a formal handling instruction INS2 to the target switch 10T.

The controller 200 includes one or more processors 201 (hereinafter simply referred to as “processors 201”) and one or more storage devices 202 (hereinafter simply referred to as “storage devices 202”). The processor 201 carries out various information processing. For example, the processor 201 includes a CPU. The storage device 202 stores various information necessary for the processing executed by the processor 201. As the storage device 202, a volatile memory, a non-volatile memory, HDD, SSD, and the like are exemplified.

A communication control program 203 is a computer program executed by the processor 201. The function of the controller 200 is realized by cooperation of the processor 201 executing the communication control program 203 and the storage device 202. The communication control program 203 is stored in the storage device 202. The communication control program 203 may be recorded on a computer-readable recording medium. The communication control program 203 may be provided to the controller 200 via a network.

As another example, controller 200 may be realized using hardware such as the ASIC, the PLD, or the FPGA.

### 2-1-3. Example of Functional Configuration

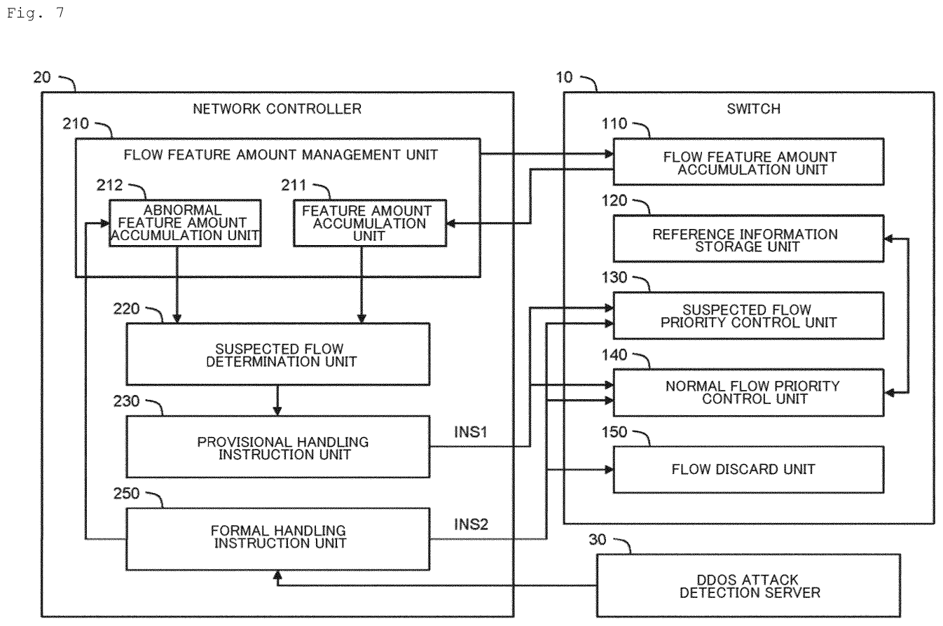

FIG. 7 is a block diagram showing an example of the functional configuration of the communication system 1 according to the present embodiment. FIG. 7 shows, in particular, an example of a functional configuration related to a provisional handling and a formal handling.

The switch 10 includes, as function blocks, a flow feature amount accumulation unit 110, a reference information storage unit 120, a suspected flow priority control unit 130, a normal flow priority control unit 140, and a flow discard unit 150. These functional blocks are realized by the controller 100.

The network controller 20 includes, as function blocks, a flow feature amount management unit 210, a suspected flow determination unit 220, a provisional handling instruction unit 230, and a formal handling instruction unit 250. These functional blocks are realized by the controller 200.

Hereinafter, processing related to the provisional handling and the formal handling according to the present embodiment is described in more detail.

### 2-2. Suspected Flow Determination

The flow feature amount accumulation unit 110 of the switch 10 accumulates information about “feature quantities” of communication flows handled by the switch 10. As the feature amount, the number of arriving frames, data rate, destination MAC (Media Access Control) address, source MAC address, Ethernet (registered trademark) type number (EthernetTypeNumber), frame length, number of session connection frames for each flow, IP (Internet Protocol) address, and port number, or the like are exemplified.

A flow feature amount management unit 210 of the network controller 20 periodically requests the flow feature amount accumulation unit 110 of each switch 10 to provide information. A flow feature amount accumulation unit 110 of each switch 10 transmits feature amount information indicating a feature amount for each communication flow to a flow feature amount management unit 210. The flow feature amount management unit 210 includes a feature amount accumulation unit 211 and an abnormal feature amount accumulation unit 212. The feature amount accumulation unit 211 stores feature amount information collected from each switch 10. The abnormal feature amount accumulation unit 212 stores abnormal feature amount information related to a communication flow determined as an abnormal flow by the DDoS attack detection server 30 in the past.

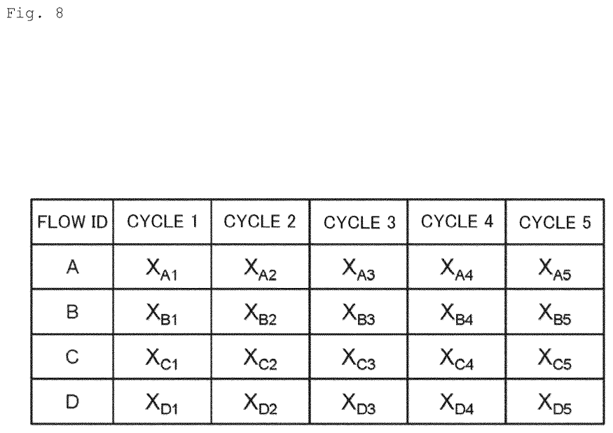

FIG. 8 is a conceptual diagram showing an example of the feature amount information stored in the feature amount accumulation unit 211. The feature amount information indicates a feature amount for each communication flow. The flow ID is identification information of a communication flow, for example, a VLAN ID (VID). In the example shown in FIG. 8, the feature amount information indicates the feature amount of the past five cycles for each communication flow. The feature amount Xᵢⱼ represents a feature amount in a cycle j of the communication flow of the identification information i.

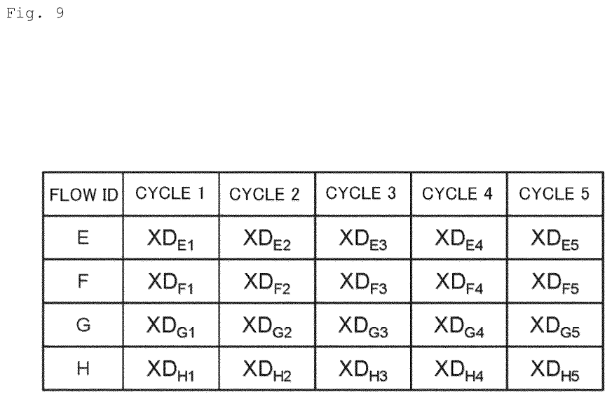

FIG. 9 is a conceptual diagram showing an example of the abnormal feature amount information stored in the abnormal feature amount accumulation unit 212. The abnormal feature amount information is feature amount information related to the past abnormal flow, and the basic content is the same as that shown in FIG. 8. In FIG. 9, the feature amount XDᵢⱼ represents the feature amount in the cycle j of the abnormal flow of the identification information i.

The suspected flow determination unit 220 of the network controller 20 determines whether or not a suspected flow FS exists. For example, the suspected flow determination unit 220 determines the presence or absence of the suspected flow FS from the viewpoint of whether or not the feature amount of the current communication flow is similar to the feature amount of the past abnormal flow. When a feature amount of a certain communication flow is similar to a feature amount of a past abnormal flow, the suspected flow determination unit 220 detects (specifies) the communication flow as a suspected flow FS.

As an example, a suspected flow determination method based on the feature amount information shown in FIG. 8 and the abnormal feature amount information shown in FIG. 9 will be described. For example, an average square error MSE_{AE} between the feature amount X_{A}j of the communication flow (flow ID=A) and the feature amount XD_{E}j of the abnormal flow (flow ID=E) is expressed by the following formula (1).

$$\begin{matrix}[ Math . 1 ] & \\ M S {E}_{A E} = \frac{1}{n} {\sum }_{j = 1}^{r ι} {( {X}_{A j} - X {D}_{Ej} )}^{2} & ( 1 )\end{matrix}$$

A suspected flow determination unit 220 compares the average square error MSE_{AE} with a predetermined threshold. When the average square error MSE_{AE} is less than a predetermined threshold, the suspected flow determination unit 220 determines that a communication flow (flow ID=A) is similar to an abnormal flow (flow ID=E). That is, the suspected flow determination unit 220 detects a communication flow (flow ID=A) as a suspected flow FS. The same determination is performed for all combinations of the current communication flow and the past abnormal flow.

When the suspected flow FS is detected, the suspected flow determination unit 220 notifies the provisional handling instruction unit 230 of identification information (e.g., VID) of the suspected flow FS and the switch 10 handling the suspected flow FS.

### 2-3. Provisional Handling

The provisional handling instruction unit 230 of the network controller 20 selects at least one target switch 10T from the switches 10 handling the suspected flow FS. For example, the target switch 10T is a switch 10 which is an entrance of a suspected flow FS in a communication network. Then, the provisional handling instruction unit 230 transmits a provisional handling instruction INS1 to the selected target switch 10T. The provisional handling instruction INS1 is information for instructing the target switch 10T to execute provisional handling, and includes at least identification information (e.g., VID) of the suspected flow FS.

A suspected flow priority control unit 130 and a normal flow priority control unit 140 of the target switch 10T receive a provisional handling instruction INS1 from the provisional handling instruction unit 230. The suspected flow priority control unit 130 and the normal flow priority control unit 140 execute temporary measures according to the provisional handling instruction INS1.

Specifically, the suspected flow priority control unit 130 sets the priority of the suspected flow FS to the designated priority PS. The designated priority PS is a relatively low priority. For example, the designated priority PS is the lowest priority PG.

On the other hand, the normal flow priority control unit 140 sets the priority of the normal flow FN higher than the designated priority PS. At this time, there is a possibility that both the normal flow FN requiring the change of the priority and the normal flow FN not requiring the change of the priority exist. The “reference information” stored in the reference information storage unit 120 is information to be referred to when determining a normal flow FN for changing the priority. The normal flow priority control unit 140 determines how to change the priority of which normal flow FN is to be changed on the basis of the reference information. A specific example of the reference information and the method of determining the reference information will be described later. In any case, the normal flow priority control unit 140 sets the priority of the normal flow FN higher than the designated priority PS.

The priority of the communication flow is defined by, for example, a CoS (Class of Service) value in the header. In this case, the priority of the communication flow is changed by rewriting the CoS value. For example, the L2 frame is further encapsulated by the L2 frame. At the time of encapsulation, the CoS value is rewritten to a value different from the original value.

As shown in FIG. 3, each switch 10 includes a queue 11 provided for each priority. The data (frame) of the communication flow is stored in the queue 11 associated with the priority of the communication flow. The data transmission frequency from each queue 11 depends on the priority, and the higher the priority queue 11, the higher the data transmission frequency. As a result, the higher priority communication flow, the higher the data transfer rate. Conversely, the lower priority communication flow, the lower the data transfer rate.

### 2-4. DDoS Attack Determination

On the other hand of the provisional handling, the DDoS attack detection server 30 precisely determines whether or not the suspected flow FS is caused by the DDoS attack on the basis of the data of the suspected flow FS. Then, the DDoS attack detection server 30 notifies the formal handling instruction unit 250 of the network controller 20 of information indicating the determination result.

### 2-5. Formal Handling

A formal handling instruction unit 250 of the network controller 20 receives information indicating a determination result by the DDoS attack detection server 30. When it is determined that the suspected flow FS is an abnormal flow for performing DDoS attack, the formal handling instruction unit 250 transmits a formal handling instruction INS2 to the target switch 10T described above. The formal handling instruction INS2 is information for instructing the target switch 10T to execute formal handling, and includes at least identification information of a suspected flow FS (abnormal flow).

The suspected flow priority control unit 130, the normal flow priority control unit 140, and a flow discard unit 150 of the target switch 10T receive a formal coping instruction INS2 from the formal handling instruction unit 250. The suspected flow priority control unit 130, the normal flow priority control unit 140, and the flow discard unit 150 execute formal handling according to the formal handling instruction INS2.

More specifically, the suspected flow priority control unit 130 returns the priority of the suspected flow FS (abnormal flow) to the original priority (that is, the priority before the provisional handling). Further, the flow discard unit 150 discards the frame of the suspected flow FS (abnormal flow) to block the suspected flow FS (abnormal flow). On the other hand, the normal flow priority control unit 140 returns the priority of the normal flow FN to the original priority (that is, the priority before the provisional handling).

The formal handling instruction unit 250 notifies an abnormal feature amount accumulation unit 212 of information on the abnormal flow. An abnormal feature amount accumulation unit 212 acquires feature amount information on the communication flow determined to be an abnormal flow from the feature amount accumulation unit 211, and newly stores the feature amount information as abnormal feature amount information. That is, the abnormal feature amount accumulation unit 212 updates the abnormal feature amount information.

### 2-6. Restoration Processing

When it is determined that the suspected flow FS does not perform DDoS attack, the formal handling instruction unit 250 transmits a restoration instruction to the target switch 10T. The restoration instruction instructs to return the priority changed in the provisional handling to the original priority before the provisional handling.

The suspected flow priority control unit 130 and the normal flow priority control unit 140 of the target switch 10T receive a restoration instruction from the formal handling instruction unit 250. The suspected flow priority control unit 130 and the normal flow priority control unit 140 execute restoration processing according to the restoration instruction. More specifically, the suspected flow priority control unit 130 returns the priority of the suspected flow FS from the designated priority PS to the original priority (that is, the priority before the provisional handling). Further, the normal flow priority control unit 140 returns the priority of the normal flow FN to the original priority (that is, the priority before the provisional handling).

### 2-7. Processing Flow

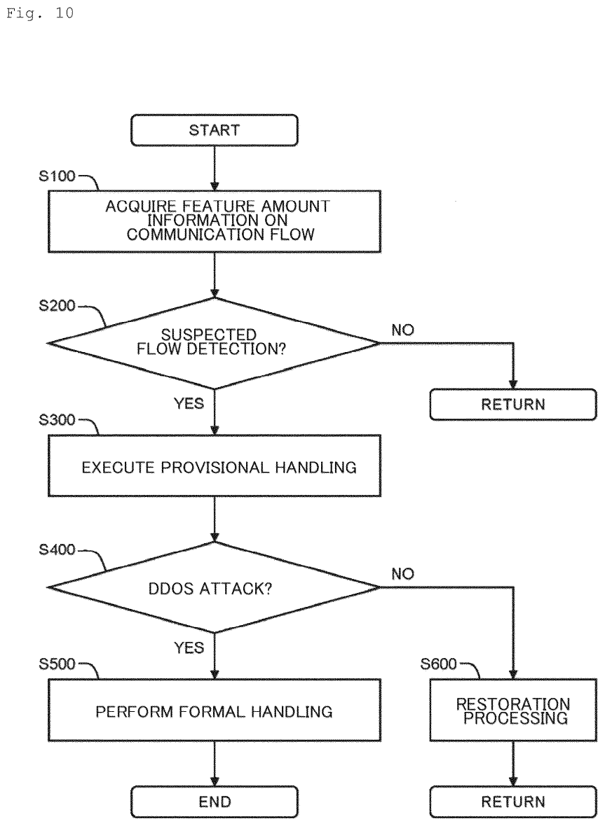

FIG. 10 is a flowchart that summarizes processing related to the provisional handling and formal handling according to the present embodiment.

In step S100, each switch 10 acquires feature amount information related to a communication flow. The network controller 20 acquires feature amount information from each switch 10.

In step S200, the network controller 20 determines whether or not a suspected flow FS exists on the basis of the feature amount information (refer to the section 2-2 described above). When the suspected flow FS exists, that is, when the suspected flow FS is detected (step S200; Yes), the processing proceeds to step S300. In other cases (step S200; No), the processing returns to step S100.

In step S300, a provisional handling is executed (refer to the section 2-3 described above). The network controller 20 transmits a provisional handling instruction INS1 to the target switch 10T. The target switch 10T sets the priority of the suspected flow FS to the designated priority PS and sets the priority of the normal flow FN to be higher than the designated priority PS according to the provisional handling instruction INS1.

In step S400, the DDoS attack detection server 30 determines whether or not the suspected flow FS is caused by the DDoS attack (refer to the section 2-4 described above). When it is determined that the suspected flow FS is an abnormal flow for performing DDoS attack (step S400; Yes), the processing proceeds to step S500. In other cases (step S400; No), the processing proceeds to step S600.

In step S500, a formal handling is performed (see section 2-5 above). The network controller 20 transmits a formal handling instruction INS2 to the target switch 10T. The target switch 10T cuts off the suspected flow FS (abnormal flow) according to the formal handling instruction INS2, and returns the priority of the normal flow FN to the original priority.

In step S600, restoration processing is executed (refer to the section 2-6 described above). The network controller 20 transmits a restoration instruction to the target switch 10T. The target switch 10T returns the priority of the suspected flow FS from the designated priority PS to the original priority and returns the priority of the normal flow FN to the original priority according to the restoration instruction.

### 3. Various Examples of Priority Control

Various examples of priority control in provisional handling (step S300) are described below. In the following example, the designated priority PS is assumed to be the lowest priority P0, the lowest of several priorities.

### 3-1. First Example

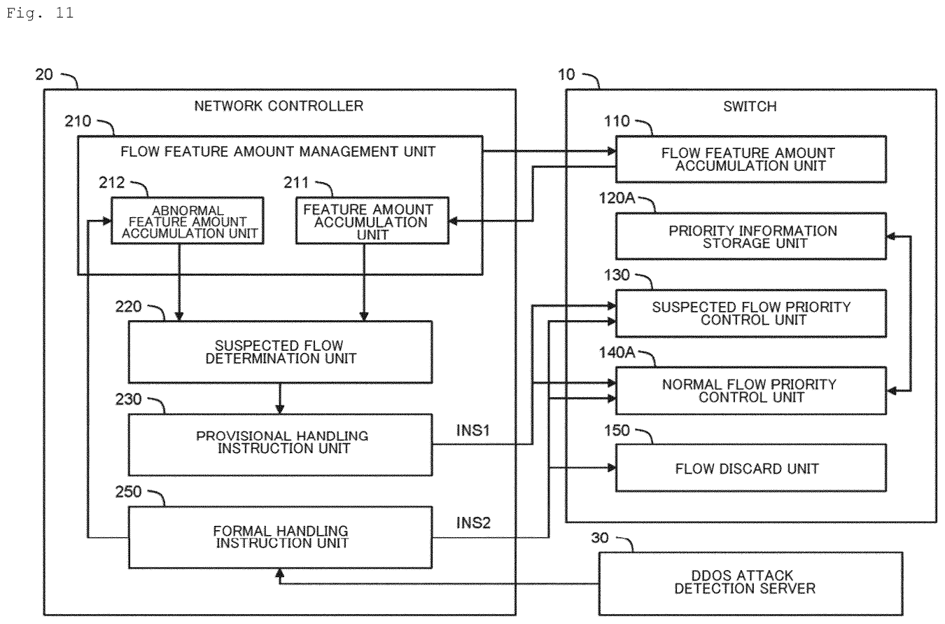

FIG. 11 is a block diagram for explaining a first example of priority control in the provisional handling. In a first example, the reference information storage unit 120 is a priority information storage unit 120A for storing “priority information”. The priority information indicates the priority for each communication flow handled by the switch 10. The priority in this case is the priority at the time when the data (frame) of the communication flow is inputted to the switch 10. The priority information storage unit 120A monitors the communication flow and periodically updates the priority information.

The suspected flow priority control unit 130 sets the priority of the suspected flow FS to the lowest priority P0. A normal flow priority control unit 140A sets the priority of the normal flow FN higher than the lowest priority P0 on the basis of the priority information stored in the priority information storage unit 120A.

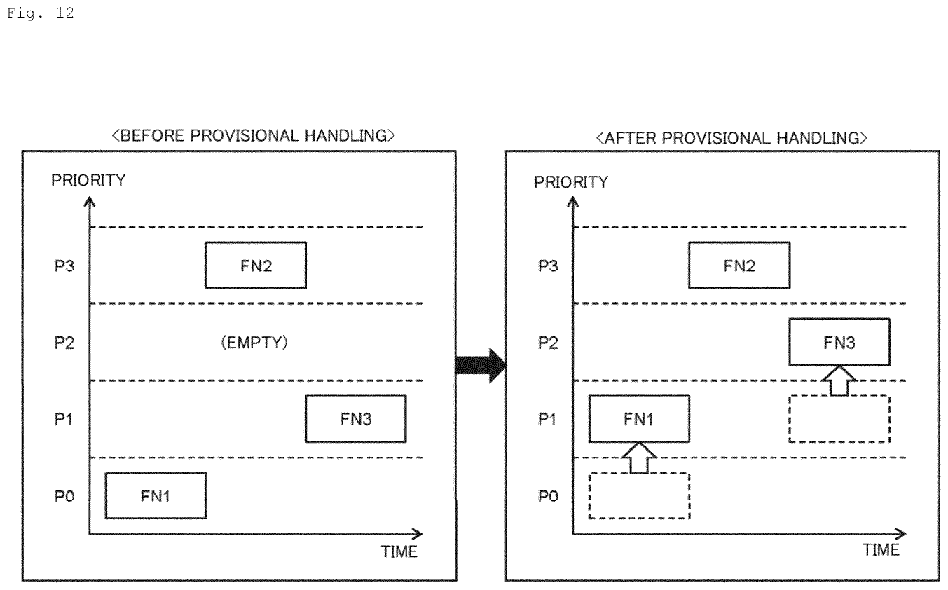

FIG. 12 is a conceptual diagram for explaining a first example of priority control. The abscissa represents time, and the ordinate represents priority. Here, we consider the case where there is a plurality of priorities P0 to P3 and three types of normal flows FN1 to FN3. The respective frames of the normal flows FN1 to FN3 arrive at the switch 10. Before the provisional handling, the priority of the normal flow FN1 is P0, the priority of the normal flow FN2 is P3, and the priority of the normal flow FN3 is P1. The priority P2 is “empty priority” not allocated to any normal flow FN. In this case, in the provisional handling, the normal flow priority control unit 140A increases the priority of each of the normal flows FN1 and FN3 lower in priority than the empty priority P2 by one step. As a result, the priority of the normal flow FN1 is increased to P1, and the priority of the normal flow FN3 is increased to P2. Thus, the priority of all normal flows FN1 to FN3 becomes higher than the priority of the suspected flow FS, that is, the lowest priority P0.

Generalization is as follows. The priority information indicates an allocation state of priority to the communication flow before the provisional handling. The normal flow priority control unit 140A searches for “empty priority” which is not allocated to the normal flow FN from among a plurality of priorities other than the lowest priority P0 on the basis of the priority information. For example, the normal flow priority control unit 140A searches for empty priority from a lower priority side to a higher priority side. When the empty priority is found, the search is terminated. When the empty priority is found, the normal flow priority control unit 140A increases the priority of the normal flow FN whose priority before the provisional handling is lower than the empty priority by one step.

In this way, according to the first example of the priority control, the priority of all normal flows FN becomes higher than the priority of the suspected flow FS, that is, the lowest priority P0. Also, even if provisional handling is taken, the magnitude relation of priority among the plurality of normal flows FN is maintained.

As an alternative example, the network controller 20 may search the empty priority on the basis of the priority information instead of the switch 10. In that case, the provisional handling instruction INS1 includes information on the empty priority found.

### 3-2. Second Example

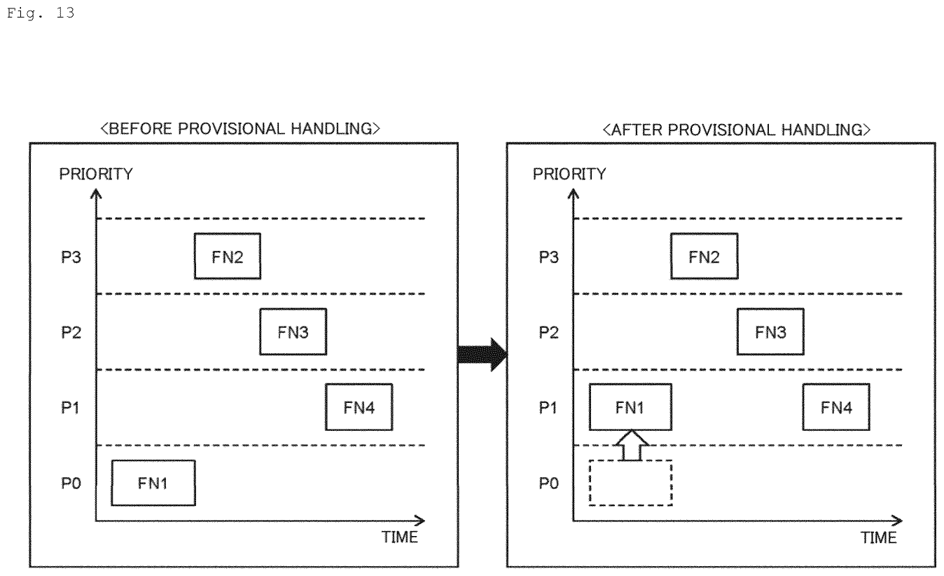

FIG. 13 is a conceptual diagram for explaining a second example of priority control. Here, we consider the case where there are a plurality of priorities P0 to P3 and three types of normal flows FN1 to FN4. Each frame of the normal flows FN1 to FN4 has arrived at the switch 10. Before the provisional handling, the priority of the normal flow FN1 is P0, the priority of the normal flow FN2 is P3, the priority of the normal flow FN3 is P2, and the priority of the normal flow FN4 is P1. In the provisional handling, the normal flow priority control unit 140A increases at least the priority of the normal flow FN1 from the lowest priority P0. For example, the normal flow priority control unit 140A increases the priority of the normal flow FN1 by one step. As a result, the priority of the normal flow FN1 is increased to P1. Thus, the priority of all normal flows FN1 to FN4 becomes higher than the priority of the suspected flow FS, that is, the lowest priority PG.

Generalization is as follows. The “lowest priority flow” is a normal flow FN in which priority before the provisional handling is performed is the lowest priority PG. A normal flow priority control unit 140A determines whether or not the lowest priority flow exists on the basis of the priority information. When the lowest priority flow exists, the normal flow priority control unit 140A increases the priority of the lowest priority flow from the lowest priority PG. For example, the normal flow priority control unit 140A increases the priority of the lowest priority flow by one step.

In this way, according to the second example of the priority control, the priority of all normal flows FN becomes higher than the priority of the suspected flow FS, that is, the lowest priority PG. Further, priority control is realized by simple processing.

As an alternative example, the network controller 20 may determine whether or not the lowest priority flow exists on the basis of the priority information instead of the switch 10. In this case, the provisional handling instruction INS1 includes identification information of the lowest priority flow.

### 3-3. Third Example

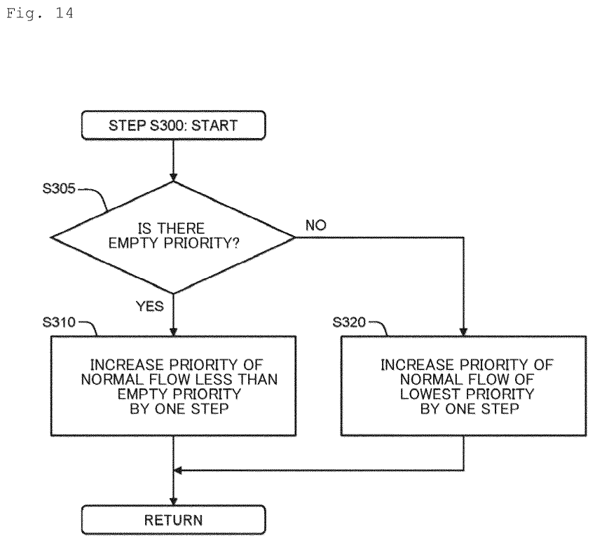

FIG. 14 is a flowchart showing a third example of priority control. The third example is a combination of the first and second examples.

In step S305, a normal flow priority control unit 140A searches for empty priority on the basis of the priority information. When the empty priority is found (step S305; Yes), the normal flow priority control unit 140A performs priority control related to the first example (step S310). On the other hand, when the empty priority is not found (step S305: No), the normal flow priority control unit 140A performs priority control related to the second example (step S320).

The normal flow priority control unit 140A repeatedly executes the above processing at every fixed period from the start to the end of the provisional handling. That is, the normal flow priority control unit 140A repeatedly executes the above processing on the basis of the latest priority information. Thus, the priority control can be appropriately executed according to the situation.

### 3-4. Fourth Example

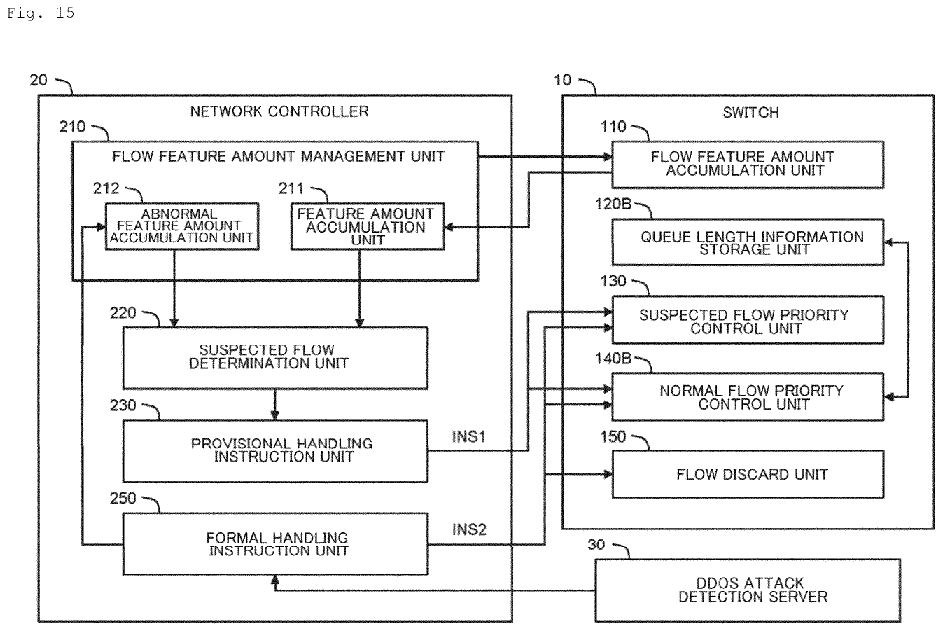

FIG. 15 is a block diagram showing a fourth example of priority control in provisional handling. In the fourth example, the reference information storage unit 120 is a queue length information storage unit 120B for storing “queue length information”. The queue length is the data amount of the communication flow stored in each queue 11 provided for each priority. The queue length information is information that indicates the queue length for each queue, that is, the queue length for each priority. A queue length information storage unit 120B monitors each queue 11 and periodically updates the queue length information.

The suspected flow priority control unit 130 sets the priority of the suspected flow FS to the lowest priority P0. A normal flow priority control unit 140B sets the priority of the normal flow FN higher than the lowest priority P0 on the basis of the queue length information stored in the queue length information storage unit 120B.

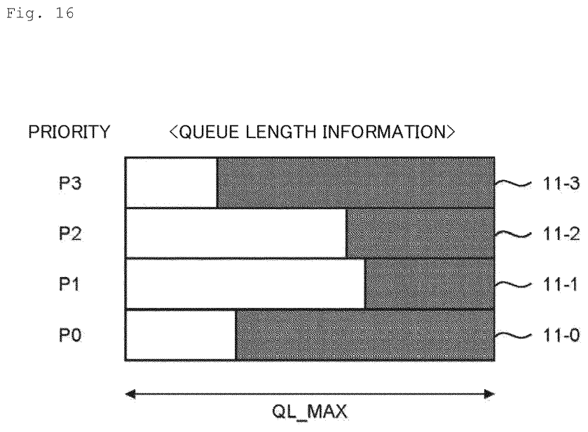

FIG. 16 is a conceptual diagram illustrating an example of queue length information. Here, we consider the case where there are a plurality of priorities P0 to P3 and a plurality of queues 11-0 to 11-3. The queue length upper limit value QL_MAX is an upper limit value of the queue length of one queue 11. The sum of the queue length of the queue 11-1 associated with the priority P1 and the queue length of the queue 11-2 associated with the priority P2 is equal to or less than a queue length upper limit value QL_MAX. In this case, even if data stored in the queue 11-1 is transferred to the queue 11-2, the queue 11-2 does not overflow.

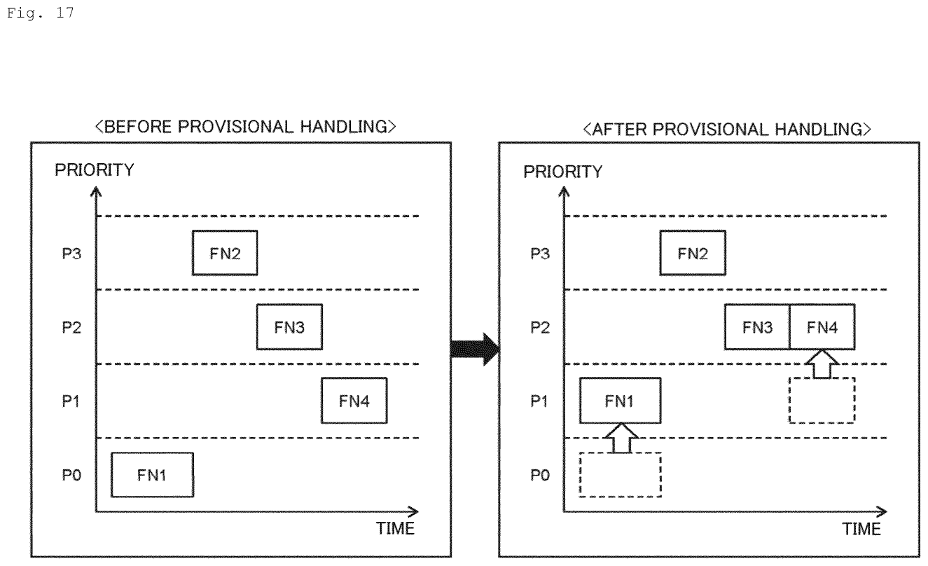

FIG. 17 is a conceptual diagram for explaining priority control in the case of the queue length information shown in FIG. 16. Before the provisional handling, the priority of the normal flow FN1 is PC, the priority of the normal flow FN2 is P3, the priority of the normal flow FN3 is P2, and the priority of the normal flow FN4 is P1. In the provisional handling, a normal flow priority control unit 140B increases the priority of each of normal flows FN1 and FN4 having the priority P1 or less by one step. As a result, the priority of the normal flow FN1 is increased to P1, and the priority of the normal flow FN4 is increased to P2. Thus, the priority of all normal flows FN1 to FN4 becomes higher than the priority of the suspected flow FS, that is, the lowest priority PG.

Generalization is as follows. The first queue length Q1 is a queue length of a first queue in which data of a communication flow of first priority is stored. The second queue length Q2 is a queue length of a second queue in which data of a communication flow of second priority higher by one stage than the first priority is stored. A normal flow priority control unit 140 B searches a combination of first priority and second priority in which the sum of the first queue length Q1 and the second queue length Q2 is equal to or less than a queue length upper limit value QL_MAX on the basis of the queue length information. For example, the normal flow priority control unit 140B searches for such a combination of first and second priorities from the low priority side to the high priority side. If such a combination of first and second priority is found, the normal flow priority control unit 140B increases the priority of the normal flow FN whose priority before the provisional handling is lower than the first priority by one level.

When a combination of the first priority and the second priority in which the sum of the first queue length Q1 and the second queue length Q2 is equal to or less than a queue length upper limit value QL_MAX is not found, the normal flow priority control unit 140B may search a combination of the first priority and the second priority in which the sum of the first queue length Q1 and the second queue length Q2 is minimum. Then, the normal flow priority control unit 140B may increase the priority of the normal flow FN whose priority before the provisional handling is equal to or lower than the first priority by one step.

Alternatively, when a combination of the first priority and the second priority in which the sum of the first queue length Q1 and the second queue length Q2 is equal to or less than the queue length upper limit value QL_MAX is not found, the normal flow priority control unit 140B may perform the priority control according to the second example described above.

Thus, according to a fourth example of the priority control, the priority of all normal flows FN becomes higher than the priority of the suspected flow FS, that is, the lowest priority PG. Also, priority control can be appropriately performed in consideration of the queue length.

As a modified example, the network controller 20 may search for a combination of the first priority and the second priority on the basis of the queue length information instead of the switch 10. In this case, the provisional handling instruction INS1 includes information on the first priority found.

### 4. Provisional Handling in Consideration of Suspected Section

A section in which communication of the suspected flow FS is performed in the communication network is hereinafter referred to as “suspected section SS”. A provisional handling in consideration of the suspected section SS will be described below.

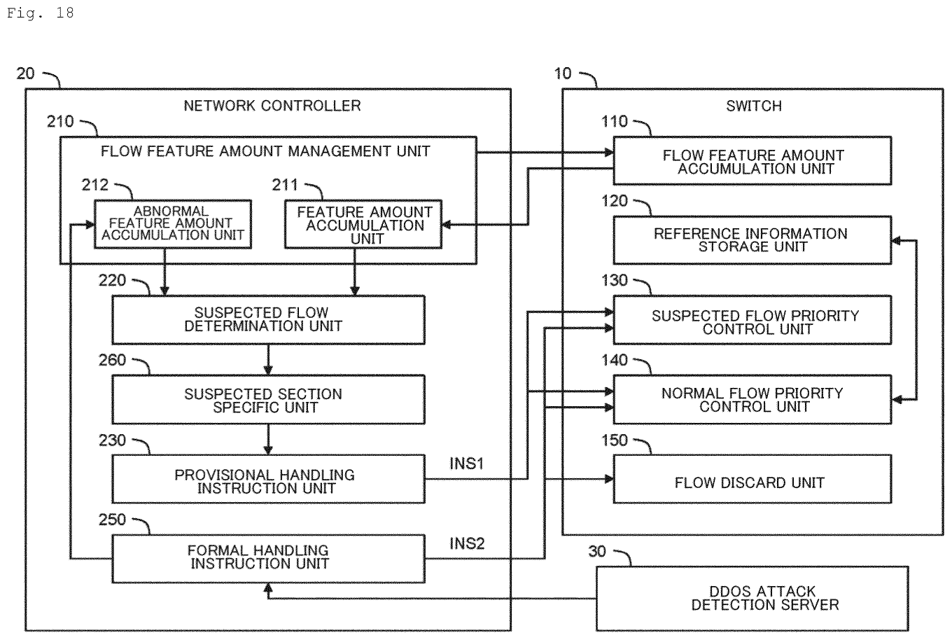

FIG. 18 is a block diagram showing an example of functional configuration related to provisional handling considering the suspected section SS. Explanations that are redundant with the existing explanations are appropriately omitted. The network controller 20 further includes a suspected section specification unit 260 for specifying a suspected section SS.

A suspected section specification unit 260 holds switch connection information indicating a connection relation between the switches 10. The switch connection information is provided, for example, from a network manager. As another example, the switch connection information may be acquired by utilizing an existing network management protocol or a path control protocol. The suspected section specification unit 260 receives information on a suspected flow FS and information on the switch 10 handling the suspected flow FS from the suspected flow determination unit 220. Then, the suspected section specification unit 260 specifies a suspected section SS in the communication network on the basis of the switch connection information and the information from the suspected flow determination unit 220.

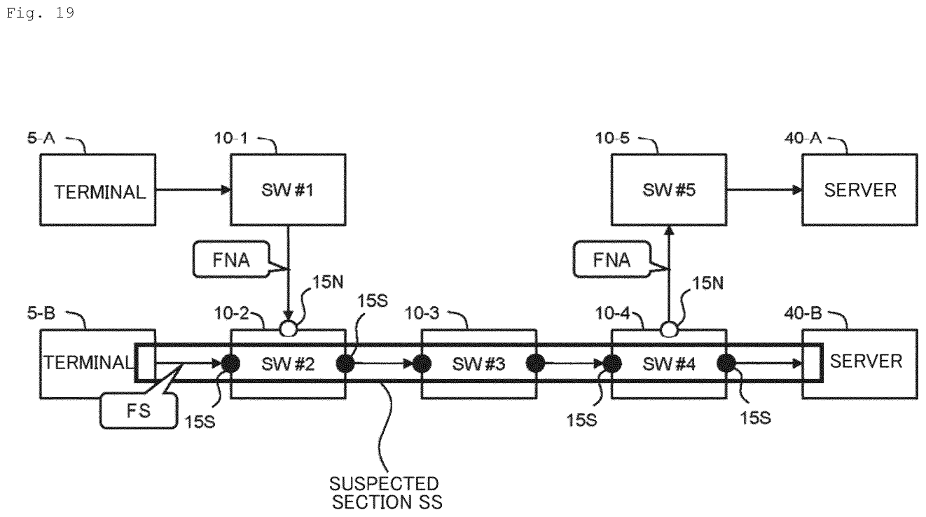

FIG. 19 is a conceptual diagram for explaining an example of a suspected section SS. The suspected flow FS reaches the server 40-B from a terminal 5-A via switches 10-2, 10-3, and 10-4.

Therefore, the suspected section SS is a section between a terminal 5-A and a server 40-B via the switches 10-2, 10-3, and 10-4.

Here, the suspected port 15S and the non-suspected port 15N will be described. The suspected port 15S is a port 15 connected to a suspected section SS among ports 15 of the switch 10. On the other hand, the non-suspected port 15N is a port 15 which is not connected to the suspected section SS among the ports 15 of the switch 10.

In the example shown in FIG. 19, the normal flow FNA reaches the server 40-A from the terminal 5-A via the switches 10-1, 10-2, 10-3, 10-4 and 10-5. The section where the normal flow FNA flows partially overlaps the suspected section SS. With respect to the normal flow FNA, priority control is performed only in the suspected section SS. That is, the priority of the normal flow FNA is controlled to be high in the switch 10-2 which is an entrance to the suspected section SS, and returned to the original priority in the switch 10-4 which is an exit from the suspected section SS.

The switch 10-2 has not only a suspected port 15S but also a non-suspected port 15N to which a normal flow FNA is inputted. The switch 10-4 has not only a suspected port 15S but also a non-suspected port 15N from which a normal flow FNA is outputted. A provisional handling instruction unit 230 acquires identification information (e.g., IP address) of a switch 10 having both a suspected port 15S and a non-suspected port 15N from a suspected section specification unit 260. A provisional handling instruction unit 230 specifies the switches 10-2 and 10-4 on the basis of the information of each switch 10 and each communication flow. Then, a provisional handling instruction unit 230 instructs the priority control of the normal flow FNA to each of the switches 10-2, 10-4.

Generalization is as follows. The “first switch” is a switch 10 having a non-suspected port 15N to which a first normal flow is input and a suspected port 15S to which the first normal flow is output. A provisional handling instruction unit 230 instructs a normal flow priority control unit 140 of the first switch to execute provisional handling for setting the priority of the first normal flow higher than the designated priority PS. The method for increasing the priority may be any of the first to fourth examples described in the section 3.

The “second switch” is the switch 10 having a suspected port 15S to which the second normal flow is input and a non-suspected port 15N to which the second normal flow is output. A provisional handling instruction unit 230 instructs a normal flow priority control unit 140 of the second switch to return the priority of the second normal flow to the original priority (that is, the priority before the provisional handling is performed).

In this way, by considering the suspected section SS and taking provisional handling, the impact on the normal flow FN can be minimized.

### REFERENCE SIGNS LIST

1 Communication system
Terminal
Switch
10T Target switch
11 Queue
12 Port
Port
15N Non-suspected port
15S Suspected port
Network controller
21 Communication interface
DDoS attack detection server
Server
100 Controller
101 Processor
102 Storage device
103 Communication control program
110 Flow feature amount accumulation unit
120 Reference information storage unit
120A Priority information storage unit
120B Queue length information storage unit
130 Suspected flow priority control unit
140, 140A, 140B Normal flow priority control unit
150 Flow discard unit
200 Controller
201 Processor
202 Storage device
203 Communication control program
210 Flow feature amount management unit
211 Feature amount accumulation unit
212 Abnormal feature amount accumulation unit
220 Suspected flow determination unit
230 Provisional handling instruction unit
250 Formal handling instruction unit
260 Suspected section specification unit
FN Normal flow
FS Suspected flow
INS1 Provisional handling instruction
INS2 Formal handling instruction
P0 to P(N-1) Priority
SS Suspected section

1. A switch in a communication network, the switch comprising:
a memory storing instructions; and
a controller for, based on the instructions, controlling a communication flow in the communication network, wherein:
a suspected flow is the communication flow suspected of being related to a DDoS (Distributed Denial of Service) attack,
a normal flow is the communication flow other than the suspected flow,
the controller is configured to execute, based on the instructions, provisional handling when receiving a provisional handling instruction indicating identification information of the suspected flow from a network controller,
the provisional handling includes processing of setting a priority of the suspected flow to a designated priority, and
processing of setting a priority of the normal flow higher than the designated priority.

2. The switch according to claim 1, wherein:
the designated priority is a lowest priority that is the lowest among a plurality of priorities,
the provisional handling includes processing of searching for an empty priority not allocated to the normal flow from the plurality of priorities other than the lowest priority, and
processing of increasing the priority of the normal flow in which the priority before the provisional handling is performed is lower than the empty priority by one step when the empty priority is found.

3. The switch according to claim 1, wherein:
the designated priority is a lowest priority that is the lowest among a plurality of priorities,
a lowest priority flow is the normal flow in which the priority before the provisional handling is performed is the lowest priority,
the provisional handling includes processing of increasing the priority of at least the lowest priority flow from the lowest priority.

4. The switch according to claim 1, further comprising:
a queue provided for each of the priorities, wherein:
a queue length is a data amount of the communication flow stored in each queue,
a first queue length is the queue length of the queue in which data of the communication flow of a first priority is stored,
a second queue length is the queue length of the queue in which data of the communication flow having a second priority higher than the first priority by one step is stored,
the designated priority is a lowest priority that is the lowest among a plurality of priorities,
the provisional handling includes processing of searching for a combination of the first priority and the second priority for which the sum of the first queue length and the second queue length is less than or equal to a queue length upper limit value, or processing of searching for a combination of the first priority and the second priority for which a sum of the first queue length and the second queue length is minimum, and
processing of increasing the priority of the normal flow in which the priority before the provisional handling is performed is less than or equal to the first priority by one step when the combination of the first priority and the second priority is found.

5. A network controller, which is connected to a switch for controlling a communication flow in a communication network, the network controller, comprising:
a memory storing instructions, and
a controller for performing, based on the instructions, communication with the switch, wherein:
a suspected flow is the communication flow suspected of being related to a DDoS (Distributed Denial of Service) attack,
a normal flow is the communication flow other than the suspected flow,
the controller is configured to perform processing, based on the instructions, of acquiring feature amount information indicating a feature amount for each of the communication flows from the switch,
processing of detecting the suspected flow on the basis of the feature amount information, and
processing of instructing the switch to execute provisional handling when the suspected flow is detected,
the provisional handling includes processing of setting a priority of the suspected flow to a designated priority, and
processing of setting a priority of the normal flow higher than the designated priority.

6. The network controller according to claim 5, wherein:
the controller is further configured to execute processing of identifying a suspected section in which a communication of the suspected flow is performed in the communication network,
a suspected port is a port connected to the suspected section among ports of the switch,
the non-suspected port is a port not connected to the suspected section among the ports of the switch,
the first switch is the switch having the non-suspected port to which a first normal flow is input and the suspected port to which the first normal flow is output,
the second switch is the switch having the suspected port to which a second normal flow is input and the non-suspected port to which the second normal flow is output,
the controller instructs the first switch to execute the provisional handling for setting the priority of the first normal flow higher than the designated priority, and
instructs the second switch to return the priority of the second normal flow to an original priority before being performed the provisional handling.

7. A communication control method, in a communication system including a switch for controlling a communication flow in a communication network, the communication control method including:
processing of acquiring feature amount information indicating a feature amount for each of the communication flows;
processing of detecting a suspected flow that is the communication flow suspected to be related to a DDoS(Distributed Denial of Service) attack on the basis of the feature amount information; and
processing that executes provisional handling when the suspected flow is detected, wherein
the provisional handling includes processing of setting a priority of the suspected flow to a designated priority, and
processing of setting priority of a normal flow that is the communication flow other than the suspected flow higher than the designated priority.

8. (canceled)
